(19) United States
(12) Patent Application Publication
(10) Pub. No.: US 2020/0098497 A1
(43) Pub. Date: Mar. 26, 2020

(54) RARE EARTH MAGNET AND PRODUCTION METHOD THEREOF

(71) Applicants: TOYOTA JIDOSHA KABUSHIKI KAISHA, Toyota-shi (JP); TOHOKU UNIVERSITY, Sendai-shi (JP)

(72) Inventors: Noritsugu SAKUMA, Mishima-shi (JP); Tetsuya SHOJI, Susono-shi (JP); Akihito KINOSHITA, Mishima-shi (JP); Kazuaki HAGA, Toyota-shi (JP); Daisuke ICHIGOZAKI, Toyota-shi (JP); Yukio TAKADA, Nagakute-shi (JP); Satoshi SUGIMOTO, Sendai-shi (JP); Masashi MATSUURA, Sendai-shi (JP)

(73) Assignees: TOYOTA JIDOSHA KABUSHIKI KAISHA, Toyota-shi (JP); TOHOKU UNIVERSITY, Sendai-shi (JP)

(21) Appl. No.: 16/576,347

(22) Filed: Sep. 19, 2019

(30) Foreign Application Priority Data
Sep. 21, 2018 (JP) 2018-178106

(51) Int. Cl. H01F 1/059; H01F 41/02; B22F 3/24; C22C 18/02; C22C 38/00

(52) U.S. Cl. CPC H01F 1/0596; H01F 41/0266; B22F 3/24; C22C 18/02; C22C 2202/02; B22F 2003/248; B22F 2301/355; B22F 2301/30; C22C 38/005

(57) ABSTRACT

To provide a rare earth magnet in which particles of SmFeN powder are bound using a Zn powder, wherein generation of a knick at a magnetic field of around 0 is prevented and high residual magnetic flux density Br is thereby achieved, and a production method thereof.

A rare earth magnet including a main phase containing Sm, Fe, and N, at least a part of the main phase having a Th₂Zn₁₇-type or Th₂Ni₁₇-type crystal structure, a sub-phase containing Zn and Fe and being present around the main phase, and an intermediate phase containing Sm, Fe and N as well as Zn and being present between the main phase and the sub-phase, wherein the average Fe content in the sub-phase is 33 at % or less relative to the whole sub-phase.

### TECHNICAL FIELD

The present disclosure relates to a rare earth magnet, particularly, a rare earth magnet containing Sm, Fe and N, at least a part thereof including a phase having a Th₂Zn₁₇-type or Th₂Ni₁₇-type crystal structure, and a production method thereof.

### BACKGROUND ART

As a high-performance rare earth magnet, a Sm-Co-based rare earth magnet and a Nd-Fe-B-based rare earth magnet are put into practical use, but in recent years, a rare earth magnet other than these is being studied.

For example, a rare earth magnet containing Sm, Fe and N (hereinafter, sometimes referred to as “Sm-Fe-N-based rare earth magnet”) is being studied. In the Sm-Fe-N-based rare earth magnet, N is considered to form an interstitial solid solution in a Sm—Fe crystal.

The Sm-Fe-N-based rare earth magnet is produced using, for example, a magnetic powder containing Sm, Fe and N (hereinafter, sometimes referred to as “SmFeN powder”). In the SmFeN powder, N is likely to dissociate and decompose due to heat. Accordingly, the Sm-Fe-N-based rare earth magnet is often produced by molding a SmFeN powder with use of a resin and/or rubber, etc.

As the production method of an Sm-Fe-N-based rare earth magnet other than the above, for example, Patent Document 1 discloses a production method of mixing a SmFeN powder and a Zn-containing powder (hereinafter, sometimes referred to as “Zn powder”), molding the mixture, and heat-treating the molded body.

### RELATED ART

### Patent Document

[Patent Document 1] Japanese Unexamined Patent Publication No. 2015-201628

### SUMMARY OF THE INVENTION

### Technical Problem

In the production method of a rare earth magnet disclosed in Patent Document 1, a SmFeN powder and a Zn powder are heat-treated together at a temperature lower than the temperature at which N of the SmFeN powder dissociates and decomposes, and Zn thereby functions as a bond for binding particles of the SmFeN powder. However, as found by the present inventors, the rare earth magnet disclosed in Patent Document 1 has a problem that a knick is generated at a magnetic field of around 0 in the M-H curve and the residual magnetic flux density Br decreases. Incidentally, the knick indicates that in a region other than the coercive three region of the M-H curve (magnetization-magnetic field curve), the magnetization is rapidly reduced with a slight decrease in the magnetic field.

The present disclosure has been made to solve the above-described problem. More specifically, an object of the present invention is to provide a rare earth magnet in which particles of SmFeN powder are bound using a Zn powder, wherein generation of a knick at a magnetic field of around 0 is prevented and high residual magnetic flux density Br is thereby achieved, and a production method thereof.

### Solution to Problem

The present inventors have made many intensive studies so as to attain the object above and accomplished the rare earth magnet of the present disclosure and the production method thereof. The rare earth magnet of the present disclosure and the production method thereof include the following embodiments.

<1> A rare earth magnet including

a main phase containing Sm, Fe, and N, at least a part of the main phase having a Th₂Zn₁₇-type or Th₂Ni₁₇-type crystal structure,

a sub-phase containing Zn and Fe and being present around the main phase, and

an intermediate phase containing Sm, Fe and N as well as Zn and being present between the main phase and the sub-phase,

wherein the average Fe content in the sub-phase is 33 at % or less relative to the whole sub-phase.

<2> The rare earth magnet according to item <1>, wherein the average Fe content in the sub-phase is from 1 to 33 at % relative to the whole sub-phase.

<3> The rare earth magnet according to item <1> or <2>, wherein the sub-phase contains one or more Zn—Fe alloy phases selected from the group consisting of a Γ phase, a Γ₁ phase, a δ₁ₖ phase, a δ₁ₚ phase, and ζ phase.

<4> The rare earth magnet according to any one of items <1> to <3>, wherein the main phase contains a phase represented by (Sm₍₁₋ᵢ₎R¹ᵢ)₂(Fe₍₁₋ⱼ₎Coⱼ)₁₇Nₕ (wherein R¹ is one or more elements selected from the group consisting of Y, Zr, and rare earth elements other than Sm, i is from 0 to 0.50, j is from 0 to 0.52, and h is from 1.5 to 4.5).

<5> The rare earth magnet according to any one of items <1> to <3>, wherein the main phase contains a phase represented by Sm₂Fe₁₇Nₕ (wherein h is from 1.5 to 4.5).

<6> The rare earth magnet according to any one of items <1> to <3>, wherein the main phase contains a phase represented by Sm₂Fe₁₇N₃.

<7> A method for producing a rare earth magnet, including:

forming a coat containing one or more elements selected from the group consisting of Si, P, Al, S, Ti, V, Ge, Y, La, Ce, Zr, Nb, Mo, Sn, Ta, Sm, and W on a particle surface of a magnetic powder including a main phase containing Sm, Fe and N, at least a part of the main phase having a Th₂Zn₁₇-type or Th₂Ni₁₇-type crystal structure to obtain a coated powder, and

heat-treating a mixed powder of a Zn-containing powder and the coated powder in an inert gas atmosphere or in vacuum at a temperature equal to or higher than the temperature allowing Zn to diffuse into the oxide phase on the surface of the main phase and less than the decomposition temperature of the main phase.

<8> The method according to item <7>, wherein the coat has a thickness of 1 to 10 nm.

<9> The method according to item <7> or <8>, wherein the coat contains one or more coats selected from the group consisting of a phosphoric acid-based coat, a zinc phosphate-based coat, a silica-based coat, and an alkoxysilicon-based coat.

<10> The method according to item <7> or <8>, wherein the coat contains Si and P.

<11> The method according to item <10>, wherein in the coat, Si is contained in an amount of 0.040 to 0.100 mass % relative to the coated powder.

<12> The method according to any one of items <7> to <11>, wherein the mixed powder is compression-molded to obtain a green compact and the green compact is heat-treated.

<13> The method according to item <12>, wherein the compression molding is performed in a magnetic field.

<14> The method according to any one of items <7> to <13>, wherein the mixed powder or green compact is heat-treated while pressure is applied.

<15> The method according to any one of items <7> to <14>, wherein the main phase contains a phase represented by (Sm₍₁₋ᵢ₎R¹ᵢ)₂(Fe₍₁₋ⱼ₎Coⱼ)₁₇Nₕ (wherein R¹ is one or more elements selected from the group consisting of Y, Zr, and rare earth elements other than Sm, i is from 0 to 0.50, j is from 0 to 0.52, and h is from 1.5 to 4.5).

<16> The method according to any one of items <7> to <14>, wherein the main phase contains a phase represented by Sm₂Fe₁₇Nₕ (wherein h is from 1.5 to 4.5).

<17> The method according to any one of items <7> to <14>, wherein the main phase contains a phase represented by Sm₂Fe₁₇N₃.

<18> The method according to any one of items <7> to <17>, wherein the heat treatment is performed at 350 to 500° C.

<19> The method according to any one of items <7> to <17>, wherein the heat treatment is performed at 420 to 500° C.

### Advantageous Effects of the Invention

According to the present disclosure, a rare earth magnet wherein the Fe content in the sub-phase present around the main phase is a predetermined amount or less and a high residual magnetic flux density Br is achieved by preventing generation of a knick at a magnetic field of around 0, can be provided. In addition, according to the present disclosure, a method for producing a rare earth magnet including a sub-phase having a Fe content of predetermined amount or less, wherein a coat containing an element such as Si is formed on the particle surface of SmFeN powder and Fe on the main phase surface is thereby prevented from diffusing into the sub-phase, can be provided.

### BRIEF DESCRIPTION OF THE DRAWINGS

FIG. 1 is a schematic diagram illustrating a portion of the microstructure with respect to the rare earth magnet of the present disclosure.

FIG. 2 is a schematic diagram illustrating a portion of the microstructure of the mixed powder before heat treatment in the production method of a rare earth magnet of the present disclosure.

FIG. 3 is a Fe—Zn binary equilibrium phase diagram.

FIG. 4 is a M-H curve with respect to Example 1 and Comparative Examples 1 to 3.

FIG. 5 is a diagram illustrating TEM observation results with respect to the sample of Example 3.

FIG. 6 is a diagram illustrating an electron beam diffraction pattern of the region denoted by “3” in FIG. 5.

FIG. 7 is a diagram illustrating TEM observation results and TEM-EDX line analysis results with respect to the sample of Comparative Example 3.

FIG. 8 is a schematic diagram illustrating the state of the SmFeN powder particle surface being coated with Zn in the production method of a conventional rare earth magnet.

FIG. 9 is a schematic diagram enlarging the portion surrounded by a square in FIG. 8.

FIG. 10 is a schematic diagram illustrating a portion of the microstructure with respect to a conventional rare earth magnet.

### MODE FOR CARRYING OUT THE INVENTION

The embodiments of the rare earth magnet of the present disclosure and the production method thereof are described in detail below. Incidentally, the embodiments set forth below should not be construed to limit the rare earth magnet of the present disclosure and the production method thereof.

The conventional rare earth magnet obtained by heat-treating a mixed powder of SmFeN powder and Zn powder has the following problem due to its production method. The problem is described using the drawings. When a SmFeN powder and a Zn powder are mixed, since the Zn powder particle is softer than the SmFeN powder particle, the outer periphery of the SmFeN powder particle is coated with Zn coat.

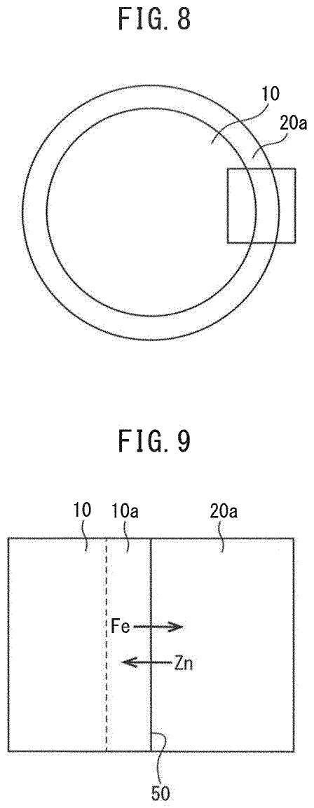

FIG. 8 is a schematic diagram illustrating the state of the SmFeN powder particle surface being coated with Zn in the production method of a conventional rare earth magnet. In FIG. 8, the main phase 10 is derived from the SmFeN powder particle, and the Zn phase 20a is derived from the Zn powder particle. The main phase 10 is a magnetic phase.

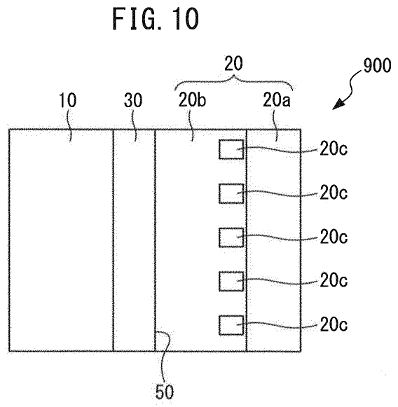

FIG. 9 is a schematic diagram enlarging the portion surrounded by a square in FIG. 8. The main phase 10 and the Zn phase 20a are contacted at an interface 50. The main phase 10 is susceptible to oxidation, and therefore at least a part of the main phase 10 surface has an oxide phase 10a. In FIG. 9, the dashed line denotes a region where the oxide phase 10a is present. When a mixed powder of SmFeN powder and Zn powder is heat-treated, Zn diffuses from the Zn phase 20a to the oxide phase 10a, and the Zn combines with oxygen of the oxide phase 10a to thrill an intermediate phase. The intermediate phase is described later. In the oxide phase 10a, Fe not constituting the main phase 10 is present, and therefore, when a mixed powder of SmFeN powder and Zn powder is heat-treated, Fe diffuses from the main phase 10 to the Zn phase 20a. In this way, the conventional rare earth magnet is obtained,

FIG. 10 is a schematic diagram illustrating a portion of the microstructure with respect to the conventional rare earth magnet 900. As a result of diffusion of Zn from the Zn phase 20a to the oxide phase 10a (see, FIG. 9), an intermediate phase 30 is formed at the position of oxide phase 10a (see, FIG. 10). In addition, as a result of diffusion of Fe from the oxide phase 10a to the Zn phase 20a (see, FIG. 9), a Zn—Fe alloy phase 20b is formed on the interface 50 side of the Zn phase 20a (see, FIG. 10) and at this time, if the amount of Fe diffused from the oxide phase 10a to the Zn—Fe alloy phase 20b is large, an α-Fe phase 20c is produced inside of the Zn—Fe alloy phase 20b.

Although the main phase 10 is a hard magnetic phase and the α-Fe phase 20c is a soft magnetic phase, as illustrated in FIG. 10, the main phase 10 and the α-Fe phase 20c are not present adjacent to each other, and exchange coupling does not act therebetween. Accordingly, the α-Fe phase 20c gives rise to a knick.

The oxide phase 10a becomes an intermediate phase 30 due to diffusion of Zn from the Zn phase 20a and contributes to enhancement of the coercive force by magnetically dividing adjacent main phases 10 from each other. Since Fe has high affinity for Zn, Fe present in the oxide phase 10a is likely to diffuse into the Zn phase 20a, and diffusion of a large amount of Fe generates production of an α-Fe phase 20c inside of the Zn—Fe alloy phase 20b. Even when diffusion of Fe present in the oxide phase 10a is suppressed and Fe remains inside of the intermediate phase 30 produced due to diffusion of Zn, since the main phase 10 (hard magnetic) and Fe (soft magnetic) inside of the intermediate phase 30 are contiguous, exchange coupling acts therebetween, contributing to enhancement of magnetization, and a knick is not generated.

The present inventors have found that such diffusion of a large amount of Fe may be suppressed when a coated powder obtained by forming a coat containing Si, etc. on the SmFeN powder particle surface is used and a mixed powder of the coated powder and Zn powder is heat-treated. In addition, the present inventors have found that when diffusion of a large amount of Fe is suppressed, an α-Fe phase 20c can be prevented from being produced inside of the Zn—Fe alloy phase 20b, as a result, generation of a knick can be inhibited.

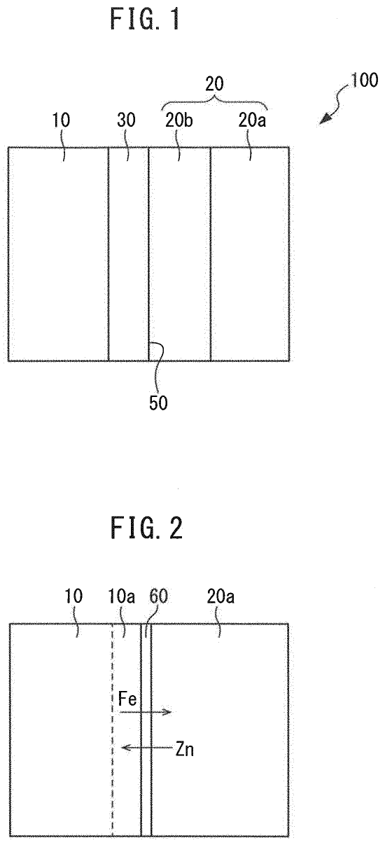

These findings are described by further referring to additional drawings, FIG. 1 is a schematic diagram illustrating a portion of the microstructure with respect to the rare earth magnet of the present disclosure. In the production of the rare earth magnet 100 of the present disclosure, before mixing SmFeN powder and Zn powder, a coat containing Si, etc. is previously formed on the SmFeN powder particle surface. FIG. 2 is a schematic diagram illustrating a portion of the microstructure of the mixed powder before heat treatment in the production method of a rare earth magnet of the present disclosure.

As illustrated in FIG. 2, a coat 60 is formed between the main phase 10 and the Zn phase 20a. An oxide phase 10a is present on the main phase 10 surface. The coat 60 contains an element having high affinity for Fe, such as Si. The SmFeN powder having formed thereon a coat 60 (coated powder) and a Zn powder are mixed to obtain a mixed powder. The mixed powder is then heat-treated, as a result, Zn diffuses from the Zn phase 20a to the oxide phase 10a (see, FIG. 2), and the Zn combines with oxygen of the oxide phase 10a to form an intermediate phase 30 (see, FIG. 1). In addition, Fe diffuses from the main phase 10 to the Zn phase 20a (see, FIG. 2), and a Zn—Fe alloy phase 20b is formed on the interface 50 side of the Zn phase 20a (see, FIG. 1). At this time, although not bound by theory, Fe combines with Si, etc. of the coat 60, and the amount of Fe diffused from the oxide phase 10a to the Zn phase 20a is reduced, as a result, the Fe content does not become excessive inside of the Zn—Fe alloy phase 20b, leading to suppression of the production of an α-Fe phase 20c (see, FIG. 10).

Since the coat 60 is thin and the content of an element combined with Fe, such as Si, present in the coat 60 is small, it is considered that the combined material of an element such as Si with Fe is also thin (small) and the content thereof is small. In practice, it is difficult to confirm the combined material by structure observation and component analysis, etc. The present inventors is considered the reason why despite the fact that the combined material of an element such as Si with Fe is thin (small) in this way and the content thereof is small, diffusion of a large amount of Fe can be suppressed is as follows. Although not bound by theory, the combined material of an element such as Si with Fe is considered to act as a barrier for diffusion of Fe or retard the diffusion of Fe.

The size and amount of the combined material of an element such as Si with Fe are so small as to make the confirmation by structure observation, and component analysis, etc. difficult, and therefore it is considered that, in practice, this combined material is less likely to adversely affect the magnetic properties, etc. of the rare earth magnet 100 of the present disclosure.

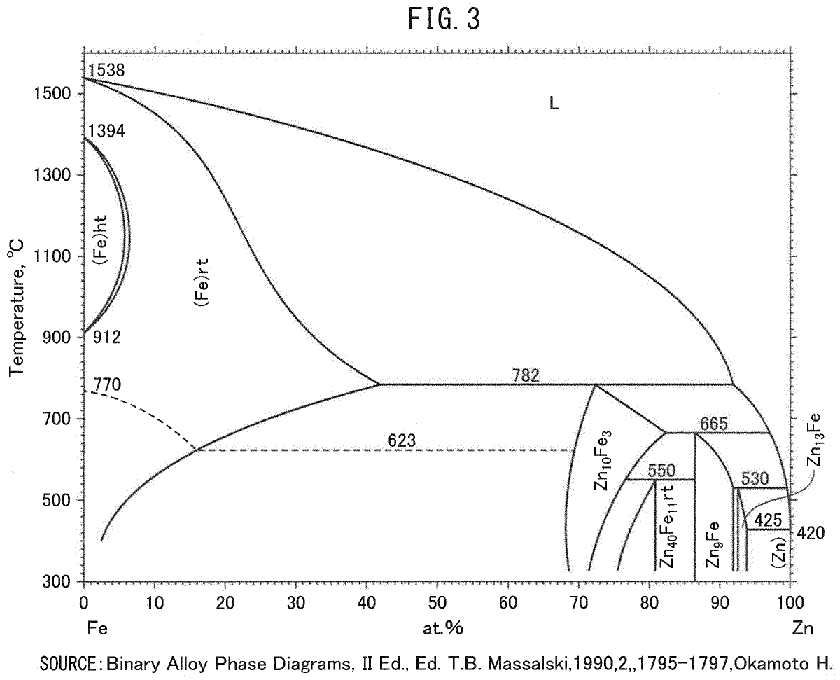

The reason why when the amount of Fe diffused from the oxide phase 10a to the Zn phase 20a is reduced, production of an α-Fe phase inside of the Zn—Fe alloy phase 20b can be suppressed is described using an equilibrium phase diagram. FIG. 3 is a Fe—Zn binary equilibrium phase diagram. The source therefor is Binary Alloy Phase Diagrams, II Ed., Ed. T. B. Massalski, 1990, 2, 1795-1797, Okamoto H.

In FIG. 3, the region denoted by “(Fe)ᵣₜ” indicates an α-Fe phase; the region denoted by “Zn₁₀Fe₃” indicates a Γ phase; the region denoted by “Zn₄₀Fe₁₁ᵣₜ” indicates a Γ₁ phase; the region denoted by “Zn₉Fe” indicates a δ₁ₖ phase or a δ₁ₚ phase; and the region denoted by “Zn₁₃Fe” indicates a ζ phase. Incidentally, as seen from FIG. 3, the α-Fe phase forms a solid solution with a small amount of Zn at 300° C. or less. Accordingly, in the present description, unless otherwise indicated, the α-Fe phase encompasses an α-(Fe, Zn) phase having formed therein a solid solution of a small amount of Zn.

As understood from FIG. 3, when the Fe content in an Fe—Zn binary system is 33 at % or less, the Γ phase, Γ₁ phase, δ₁ₖ phase, δ₁ₚ phase and ζ phase are stable. It can therefore be understood that when the Fe content is 33 at % or less, an α-Fe phase is less likely to be produced. Describing by referring to FIG. 2 (a diagram illustrating the state before heat treatment) and FIG. 1 (a diagram illustrating the state after heat treatment), this is as follows. Even when Fe diffuses from the oxide phase 10a to the Zn phase 20a (see, FIG. 2) as a result of heat treatment and a Zn—Fe alloy phase 20b is formed (see, FIG. 1), since a coat 60 of FIG. 2 is present, the amount of Fe diffused is not so large. This suggests that in FIG. 2, the Fe content in total in the Zn—Fe alloy phase 20b and the Zn phase 20a becomes 33 at % or less and an α-Fe phase can hardly be produced inside of the Zn—Fe alloy phase 20b.

On the other hand, in the production method of a conventional rare earth magnet, since the coat 60 of FIG. 2 is not present (see, FIG. 9), a large amount of Fe diffuses from the oxide phase 10a to the Zn phase 20a due to heat treatment. As a result, the Fe content in total in the Zn—Fe alloy phase 20b and the Zn phase 20a exceeds 33 at %, and therefore, as illustrated in FIG. 10, an α-Fe phase 20c is considered to be readily produced.

In FIG. 1 (the rare earth magnet 100 of the present disclosure) and FIG. 10 (the conventional rare earth magnet 900), the Zn phase 20a and Zn—Fe alloy phase 20b derived from Zn powder at the time of production of those rare earth magnets are referred to as the sub-phase 20 for convenience sake. Then, the rare earth magnet 100 of the present disclosure of FIG. 1 has a main phase 10, a sub-phase 20, and an intermediate phase 30; the intermediate phase 30 is present between the main phase 10 and the sub-phase 20; and the average Fe content in the sub-phase 20 is 33 at % or less, relative to the whole sub-phase 20. On the other hand, the conventional rare earth magnet of FIG. 10 has a main phase 10, a sub-phase 20, and an intermediate phase 30; the intermediate phase 30 is present between the main phase 10 and the sub-phase 20; and the average Fe content in the sub-phase 20 exceeds 33 at % relative to the whole sub-phase 20. Accordingly, in the conventional rare earth magnet 900, an α-Fe phase 20c is present inside of the Zn—Fe alloy phase 20b.

The constituent features of the rare earth magnet of the present disclosure and the production thereof, which have been accomplished based on the findings discussed hereinbefore, are described below.

### <<Rare Earth Magnet>>

As illustrated in FIG. 1, the rare earth magnet 100 of the present disclosure has a main phase 10, a sub-phase 20, and an intermediate phase 30. FIG. 1 illustrates a portion of the microstructure of the rare earth magnet 100 of the present disclosure. In the rare earth magnet 100 of the present disclosure, a plurality of main phases 10 and a plurality of intermediate phases 30 therearound are present, and these are connected by sub-phases 20. Each of the main phase 10, the sub-phase 20 and the intermediate phase 30 is described below.

### <Main Phase>

The rare earth magnet 100 of the present disclosure exhibits magnetism owing to the main phase 10. The main phase 10 contains Sm, Fe and N. The main phase 10 may contain R¹ as long as it does not inhibit the effects of the rare earth magnet 100 of the present disclosure and the production method thereof. R¹ is one or more elements selected from the group consisting of Y, Zr, and rare earth elements other than Sm. In addition, a part of Fe may be substituted by Co. Such a main phase 10, when expressed by the molar ratio of Sm, R¹, Fe, Co and N, is (Sm₁₋ᵢ₎R¹ᵢ)₂(Fe₍₁₋ⱼ₎Coⱼ)₁₇Nₕ. Here, h is preferably 1.5 or more, more preferably 2.0 or more, still more preferably 2.5 or more, and on the other hand, h is preferably 4.5 or less, more preferably 4.0 or less, still more preferably 3.5 or less. In addition, i may be 0 or more, 0.10 or more, or 0.20 or more, and may be 0.50 or less, 0.40 or less, or 0.30 or less, and j may be 0 or more, 0.10 or more, or 0.20 or more, and may be 0.52 or less, 0.40 or less, or 0.30 or less.

With respect to (Sm_{(1-i)R}¹ᵢ)₂(Fe₍₁₋ⱼ₎Coⱼ)₁₇Nₕ, typically, R¹ is substituted at the position of Sm of Sm₂(Fe₍₁₋ⱼ₎Coⱼ)₁₇Nₕ, but the configuration is not limited thereto. For example, R¹ may be interstitially disposed in Sm₂(Fe₍₁₋ⱼ₎Coⱼ)₁₇Nₕ.

In addition, with respect to (Sm₍₁₋ᵢ₎R¹ᵢ)₂(Fe₍₁₋ⱼ₎Coⱼ)₁₇Nₕ, typically, Co is substituted at the position of Fe of (Sm₍₁₋ᵢ₎R¹ᵢ)₂Fe₁₇Nₕ, but the configuration is not limited thereto. For example, Co may be interstitially disposed in (Sm₍₁₋ᵢ₎R¹ᵢ)₂Fe₁₇Nₕ.

Furthermore, with respect to (Sm₍₁₋ᵢ₎R¹ᵢ)₂(Fe₍₁₋ⱼ₎Coⱼ)₁₇Nₕ, h may be from 1.5 to 4.5, but typically, the configuration is (Sm₍₁₋ᵢ₎R¹ᵢ)₂(Fe₍₁₋ⱼ₎Coⱼ)₁₇N₃. The content of (Sm₍₁₋ᵢ₎R¹ᵢ)₂(Fe₍₁₋ⱼ₎Coⱼ)₁₇N₃ relative to the whole (Sm₍₁₋ᵢ₎R¹ᵢ)₂(Fe₍₁₋ⱼ₎Coⱼ)₁₇Nₕ is preferably 70 mass % or more, more preferably 80 mass % or more, still more preferably 90 mass %. On the other hand, (Sm₍₁₋ᵢ₎R¹ᵢ)₂(Fe₍₁₋ⱼ₎Coⱼ)₁₇Nₕ need not be entirely (Sm₍₁₋ᵢ₎R¹ᵢ)₂(Fe₍₁₋ⱼ₎Coⱼ)₁₇N₃. The content of (Sm₍₁₋ᵢ₎R¹ᵢ)₂(Fe₍₁₋ⱼ₎Coⱼ)₁₇N₃ relative to the whole (Sm₍₁₋ᵢ₎R¹ᵢ)₂(Fe₍₁₋ⱼ₎Coⱼ)₁₇Nₕ may be 98 mass % or less, 95 mass % or less, or 92 mass % or less.

The content of the main phase 10 relative to the whole rare earth magnet 100 of the present disclosure is preferably 70 mass % or more, preferably 75 mass % or more, and preferably 80 mass % or more. The content of the main phase 10 relative to the whole rare earth magnet 100 of the present disclosure is not 100 mass %, because the rare earth magnet 100 of the present disclosure contains a sub-phase 20 and an intermediate phase 30. On the other hand, in order to ensure appropriate amounts of sub-phase 20 and intermediate phase 30, the content of the main phase 10 relative to the whole rare earth magnet 100 of the present disclosure may be 99 mass % or less, 95 mass % or less, or 90 mass % or less.

The content of Sm₂(Fe₍₁₋ᵢ₎Coⱼ)₁₇Nₕ relative to the whole main phase 10 is preferably 90 mass % or more, more preferably 95 mass % or more, still more preferably 98 mass % or more, The content of Sm₂(Fe₍₁₋ᵢ₎Coᵢ)₁₇Nₕ relative to the whole main phase 10 is not 100 mass %, because the main phase 10 may contain a phase other than Sm₂(Fe₍₁₋ᵢ₎Coᵢ)₁₇Nₕ.

The main phase 10 of the rare earth magnet 100 of the present disclosure contains a phase that can be contained as a magnetic phase of an Sm-Fe-N-based rare earth magnet. Such a phase includes, for example, a phase having a Th₂Zn₁₇-type crystal structure, a phase having a Th₂Ni₁₇-type crystal structure, and a phase having a TbCu₇-type crystal structure.

The particle diameter of the main phase 10 is not particularly limited. The particle diameter of the main phase 10 may be, for example, 1 μm or more, 5 μm or more, or 10 μm or more, and 50 μm or less, 30 μm or less, or 20 μm or less. In the present description, unless otherwise indicated, the particle diameter means an equivalent-circle diameter of projected area, and in the case where the particle diameter is indicated with a range, 80% or more of all main phases 10 are distributed in that range.

### <Sub-Phase>

A sub-phase 20 is present around the main phase 10. As described later, an intermediate layer 30 is present between the main phase 10 and the sub-phase 20, and therefore the sub-phase 20 is present in the outer periphery of the intermediate phase 30.

As illustrated in FIG. 1, the sub-phase 20 has a Zn phase 20a and a Zn—Fe alloy phase 20b. More specifically, on the intermediate phase 30 side of the sub-phase 20, Zn is alloyed with Fe. Accordingly, the sub-phase 20 contains Zn and Fe. As described above, when the average Fe content in the sub-phase 20 is 33 at % or less relative to the whole sub-phase 20, production of an α-Fe phase 20c inside of the Zn—Fe alloy phase 20b (see, FIG. 10) can be suppressed. As a result, generation of a knick at a magnetic field of around 0 can be prevented. From the viewpoint of suppressing the production of α-Fe phase 20c, the average Fe content in the sub-phase 20 is preferably 30 at % or less, more preferably 20 at % or less, still more preferably 15 at % or less.

On the other hand, from the viewpoint of suppressing the production of α-Fe phase 20c inside of the Zn—Fe alloy phase 20b, the average Fe content in the sub-phase 20 is preferably smaller within the range of 33 at % or less, but there is substantially no problem even when it is not 0. Accordingly, the average Fe content in the sub-phase 20 may be 1 at % or more, 3 at % or more, or 5 at % or more.

As understood from the phase diagram of FIG. 3, since the Fe content in the sub-phase 20 is 33 at % or less, the phases that the sub-phase 20 can contain are the Zn phase 20a and, as the Zn—Fe alloy phase 20b, a Γ phase (Zn₁₀Fe₃), a Γ₁ phase (Zn₄₀Fe₁₁ᵣₜ), δ₁ₖ and δ₁ₚ phases (Zn₉Fe), and a ζ phase (Zn₁₃Fe). The saturation magnetization of each of these phases is shown in Table 1. Here, in Table 1, the results of measuring the saturation magnetization of a ribbon produced by rapidly cooling a molten alloy having the composition on the phase diagram of each phase are shown.

TABLE 1

| Phase | Saturation Magnetization (emu/g) |
|---|---|
| ζ phase | <0.1 |
| δ1p phase | <0.1 |
| δ1k phase | <0.1 |
| Γ1 phase | <0.1 |
| Γ phase | 6 |
| α phase | 215 |
| Sm2Fe17N3 phase | 154 |

The saturation magnetizations of Γ₁ phase, δ₁ₖ phase, δ₁ₚ phase and ζ phase are extremely low, and the saturation magnetization of Γ phase is very small compared with α-Fe phase. Accordingly, in order to prevent generation of a knick at a magnetic field of around 0, the sub-phase 20 may contain one or more Zn—Fe alloy phases selected from the group consisting of a Γ phase, a Γ₁ phase, a δ₁ₖ phase, a δ₁ₚ phase, and a phase. In particular, the sub-phase 20 may contain one or more Zn—Fe alloy phases selected from the group consisting of a Γ₁ phase, a δ₁ₖ phase, a δ₁ₚ phase, and a ζ phase. Incidentally, each of the Γ phase, Γ₁ phase, δ₁ₖ phase, δ₁ₚ phase and phase may include an intermetallic compound other than the Zn—Fe alloy phase.

As understood from FIG. 3, the Fe content decreases in order of Γ phase, Γ₁ phase, δ₁ₖ phase, δ₁ₚ phase and ζ phase (the Fe content is largest in the Γ phase). Accordingly, as the Fe content in the sub-phase 20 decreases, the Γ phase is less likely to be present, and it is easy to prevent generation of a knick at a magnetic field of around 0.

The thickness of the sub-phase 20 is not particularly limited as long as the average Fe content is in the above-described range and the production of α-Fe phase can be suppressed. The thickness of the sub-phase 20 may be typically 1 nm or more, 10 nm or more, 50 nm or more, 100 nm or more, 250 nm, or 500 nm or more, and may be 100 μm or less, 50 μm or less, or 1 μm or less.

### <Intermediate Phase>

As illustrated in FIG. 1, an intermediate phase 30 is present between the main phase 10 and the sub-phase 20. The intermediate phase 30 is formed as a result of diffusion of Zn into the oxide phase 10a of the main phase 10 illustrated in FIG. 2. Accordingly, the intermediate phase contains Sm, Fe and N as well as Zn. Diffusion of Zn magnetically divides the main phases 10 and contributes to enhancement of the coercive force.

When the Zn content in the intermediate phase 30 is 5 at % or more relative to the whole intermediate phase 30, the enhancement of coercive force due to the intermediate phase 30 can be clearly recognized. From the viewpoint of enhancing the coercive force, the Zn content in the intermediate phase 30 is preferably 10 at % or more, more preferably 15 at % or more. On the other hand, when the Zn content in the intermediate phase 30 is 50 at % or less relative to the whole intermediate phase 30, reduction in the magnetization can be suppressed. From the viewpoint of suppressing the reduction in magnetization, the Zn content in the intermediate phase 30 is preferably 30 at % or less, more preferably 20 at % or less, relative to the whole rare earth magnet 100 of the present disclosure.

### <Overall Composition>

The rare earth magnet 100 of the present disclosure may be sufficient if it has the hereinbefore-described main phase 10, sub-phase 20 and intermediate phase 30 and the overall composition thereof may be, for example, as follows.

The composition of the rare earth magnet 100 of the present disclosure is, for example, represented by SmₓR¹_{y}Fe_{(100-x-y-z-w-p-q)}Co_{z}M¹_{w}NₚO_{q}.(Zn₍₁₋ₛ₋ₜ₎M²ₛOₜ)ᵣ. SmₓR¹_{y}Fe_{(100-x-y-z-w-p-q)}Co_{z}M¹_{w}NₚO_{q} is derived from the coated powder, and (Zn₍₁₋ₛ₋ₜ₎M²ₛOₜ)ᵣ is derived from Zn powder (Zn-containing powder).

R¹ is one or more selected from Y, Zr, and rare earth elements other than Smr. M¹ is a sum of one or more elements selected from the group consisting of Si, P, Al, S, Ti, V, Ge, Y, La, Ce, Zr, Nb, Mo, Sn, Ta, Sm, and W derived from the coat 60 of FIG. 2, one or more selected from Ga, Ti, Cr, Zn, Mn, V, Mo, W, Si, Re, Cu, Al, Ca, B, Ni, and C derived from the magnetic powder (SmFeN powder before coating with the coat 60 of FIG. 2), and an unavoidable impurity element. M² is an element derived from Zn powder (Zn-containing powder) and is an impurity element other than Zn, which is unavoidably contained in Zn powder (Zn-containing powder). x, y, z, w, p, q, and r are at %, and s and t are a ratio (molar ratio).

In the present description, the rare earth element includes Se, La, Ce, Pr, Nd, Pm, Sm, Eu, Gd, Tb, Dy, Ho, Er, Tm, Yb, and Lu.

Sm is a principal element of the rare earth magnet 100 of the present disclosure, and the content thereof is appropriately determined such that the rare earth magnet 100 of the present disclosure can have the main phase 10 described above. The content x of Sm may be, for example, 4.5 at % or more, 5.0 at % or more, or 5.5 at % or more, and may be 10.0 at % or less, 9.0 at % or less, or 8.0 at % or less.

The rare earth element contained in the rare earth magnet 100 of the present disclosure is mainly Sm, but as long as the effects of the rare earth magnet of the present disclosure and the production method thereof are not inhibited, the main phase 10 may contain R¹. The content y of R¹ may be, for example, 0 at % or more, 0.5 at % or more, or 1.0 at % or more, and may be 5.0 at % or less, 4.0 at % or less, or 3.0 at % or less.

Fe is a principal element of the rare earth magnet 100 of the present disclosure and forms the main phase 10 in cooperation with Sm and N. The content thereof is the remainder after removing Sm, R¹, Co, M¹, N, and O in the formula SmₓR¹_{y}Fe_{(100-x-y-z-w-p-q)}Co_{z}M¹_{w}NₚO_{q}.

A part of Fe may be substituted by Co. When the rare earth magnet 100 of the present disclosure contains Co, the Curie temperature of the rare earth magnet 100 of the present disclosure is increased. The content z of Co may be, for example, 0 at % or more, 5 at % or more, or 10 at % or more, and may be 31 at % or less, 20 at % or less, or 15 at % or less.

M¹ represents a sum of elements derived from the coat 60 of FIG. 2, elements added for enhancing specific properties, for example, heat resistance and corrosion resistance, within the range not compromising the magnetic properties of the rare earth magnet 100 of the present disclosure, and unavoidable impurity elements. The content w of M¹ may be, for example, 0.001 at % or more, 0.005 at % or more, 0.010 at % or more, 0.050 at % or more, 0.100 at % or more, 0.500 at % or more, or 1.000 at % or more, and may be 3.000 at % or less, 2.500 at % or less, or 2.000 at % or less.

N is a principal element of the rare earth magnet 100 of the present disclosure, and the content thereof is appropriately determined such that the rare earth magnet 100 of the present disclosure can have the main phase 10 described above. The content p of N may be, for example, 11.6 at % or more, 12.5 at % or more, or 13.0 at % or more, and may be 15.6 at % or less, 14.5 at % or less, or 14.0 at % or less.

Zn binds particles of the coated powder (SmFeN powder coated with Si, etc.) and forms an intermediate phase 30 to enhance the coercive force of the rare earth magnet 100 of the present disclosure. The content of Zn derives from the blending amount of Zn powder (Zn-containing powder) at the time of production of the rare earth magnet 100 of the present disclosure. The content of Zn is preferably 0.89 at % (1 mass %) or more, more preferably 2.60 at % (3 mass %) or more, still more preferably 4.30 at % (5 mass %) or more, relative to the whole rare earth magnet 100 of the present disclosure. On the other hand, from the viewpoint of not reducing the magnetization, the content of Zn is preferably 15.20 at % (20 mass %) or less, inure preferably 11.90 at % (15 mass %) or less, still more preferably 8.20 at % (10 mass %) or less, relative to the whole rare earth magnet 100 of the present disclosure. The content of Zn is represented by (1-s-r)r at % relative to the whole rare earth magnet 100 of the present disclosure.

M²is an element derived from Zn powder (Zn-containing powder) and is an impurity element other than Zn, which is unavoidably contained in Zn powder (Zn-containing powder). The ratio (molar ratio) s of M² relative to the whole Zn powder (Zn-containing powder) may be, for example, 0 or more, 0.05 or more, or 0.10 or more, and may be 0.90 or less, 0.80 or less, or 0.70 or less. The powder may be a metallic Zn powder and at this time, the ratio (molar ratio) s of M² is 0. Incidentally, the Zn powder (Zn-containing powder) is typically metallic Zn powder. In the present description, the Zn powder means metallic Zn powder. The metallic Zn means high-purity Zn not alloyed with an element other than Zn. The purity of metallic Zn may be, for example, 90 mass % or more, 95 mass % or more, 97 mass % or more, or 99 mass % or more.

O (oxygen) is derived from the magnetic powder and the Zn powder (Zn-containing powder) and remains (is contained) in the rare earth magnet 100 of the present disclosure. Oxygen is enriched in the intermediate phase 30, so that even when the oxygen content in the whole rare earth magnet 100 of the present disclosure is comparatively high, excellent coercive force can be ensured. The oxygen content relative to the whole rare earth magnet 100 of the present disclosure may be, for example, 5.5 at % or more, 6.2 at % or more, or 7.1 at % or more, and may be 10.3 at % or less, 8.7 at % or less, or 7.9 at % or less. Incidentally, the oxygen content relative to the whole rare earth magnet 100 of the present disclosure is q+tr at %. When the oxygen content relative to the whole rare earth magnet 100 of the present disclosure is converted to mass %, the oxygen content may be 1.55 mass % or more, 1.75 mass % or more, or 2.00 mass % or more, and may be 3.00 mass % or less, 2.50 mass % or less, or 2.25 mass % or less.

### <<Production Method>>

The production method of a rare earth magnet of the present disclosure is described below. The rare earth magnet of the present disclosure may be produced by a production method other than the below-described production method as long as the constituent features described hereinbefore are satisfied. The production method of a rare earth magnet of the present disclosure (hereinafter, sometimes referred to as “production method of the present disclosure”) includes a coated powder preparation step and a heat treatment step. Each step is described below.

### <Coated Powder Preparation Step>

A coat 60 (see, FIG. 2) containing one or more elements selected from the group consisting of Si, P, Al, S, Ti, V, Ge, Y, La, Ce, Zr, Nb, Mo, Sn, Ta, Sm, and W is formed on the particle surface of a magnetic powder containing a main phase 10 to obtain a coated powder. As for the main phase 10, the same contents as those described in the rare earth magnet 100 of the present invention can apply.

The coat 60 formed on the magnetic powder particle surface contains an element having high affinity for Fe. Fe combines with an element contained in the coat 60 and is thereby prevented from diffusing from the main phase 10 to the Zn phase 20a in the later-described heat treatment step.

The element contained in the coat 60 includes Si, P, Al, S, Ti, V, Ge, Y, La, Ce, Zr, Nb, Mo, Sn, Ta, Sm, W, and a combination thereof. Such an element may produce an alloy or an intermetallic compound in a binary equilibrium phase diagram with Fe, but combining with Fe is not limited to an alloy or an intermetallic compound and may be, for example, adsorption. The coat 60 may be sufficient if it contains one or more of these elements, and the coat 60 may contain an element other than these elements. The coat 60 may contain, for example, one or more coats selected from the group consisting of a phosphoric acid-based coat, a zinc phosphate-based coat, a silica-based coat, and an alkoxysilicon-based coat.

The coat 60 can enjoy the effect of inhibiting diffusion of Fe even when it is thin, but in order to clearly recognize the effect, the thickness of the coat 60 is preferably 1 nm or more, more preferably 2 nm or more. On the other hand, if the coat 60 is thick, the combined material of an element contained in the coat 60 with Fe may adversely affect the magnetic properties of the rare earth magnet 100 of the present disclosure. From this viewpoint, the thickness of the coat 60 is preferably 10 nm or less, more preferably 5 nm or less.

The content of the element in the coat 60, which combines with Fe, may be appropriately determined according to the type of the element combining with Fe by taking into consideration the Fe diffusion inhibition, adverse effect on magnetic properties of the rare earth magnet 100 of the present disclosure, thickness of the coat 60, etc. However, the content range of Si can be basically applied as the content range for other elements. The content of Si may be 0.040 mass % or more (0.084 at % or more), 0.050 mass % or more (0.105 at % or more), or 0.060 mass % or more (0.126% or more), and may be 0.100 mass % or less (0.211 at % or less), 0.090 mass % or less (0.190 at % or less), or 0.080 mass % or less (0.169 at % or less). In the case where a plurality of elements combine with Fe, each element may have a content in the range above.

The method for forming the coat 60 is not particularly limited. The method for forming the coat 60 includes, for example, a method of forming an organic complex, a method of adsorbing nanoparticles, and a vapor phase method. The vapor phase method includes a vapor deposition method, a PVD method, a CVD method, etc. The vapor deposition method includes an arc plasma deposition method, etc.

The magnetic powder before forming the coat 60 is not particularly limited as long as it contains the main phase 10 of the rare earth magnet 100 of the present disclosure. In the later-described heat treatment step, when the oxygen content in the Zn-containing powder is small, oxygen in the magnetic powder combines with Zn diffused into the oxide phase 10a during heat treatment and is enriched in the intermediate phase 30, and therefore a magnetic powder having a comparatively large oxygen content can be used. Accordingly, the upper limit of the oxygen content in the magnetic powder may be comparatively high relative to the whole magnetic powder. The oxygen content in the magnetic powder may be, for example, 3.0 mass % or less, 2.5 mass % or less, or 2.0 mass % or less, relative to the whole magnetic raw material powder. On the other hand, although the oxygen content in the magnetic powder is preferably smaller, if the amount of oxygen in the magnetic powder is extremely reduced, this leads to an increase in the production cost. For this reason, the oxygen content in the magnetic powder may be 0.1 mass % or more, 0.2 mass % or more, or 0.3 mass % or more, relative to the whole magnetic powder.

The particle diameter of the magnetic powder is not particularly limited. The particle diameter of the magnetic powder may be, for example, 1 μm or more, 5 μm or more, or 10 μm or more, and may be 50 μm or less, 30 μm or less, or 20 μm or less.

### <Heat Treatment Step>

A mixed powder of coated powder and Zn-containing powder is heat-treated. As described above, the Zn-containing powder is soft, and therefore, when the coated powder and the Zn-containing powder are mixed, the surface of the coated powder particle is coated with Zn (see, FIG. 2). Diffusing of Zn into the coated powder particle means that, as illustrated in FIG. 2, Zn diffuses from the Zn phase 20a to the main phase 10. Then, as illustrated in FIG. 1, an intermediate phase 30 is formed. At this time, Fe diffuses from the main phase 10 to the Zn phase 20a as illustrated in FIG. 2, as a result, a Zn—Fe alloy phase 20b is formed as illustrated in FIG. 1. However, the coat 60 blocks excessive diffusion of Fe from the main phase 10 to the Zn phase 20a, and therefore, unlike the conventional rare earth magnet 900, an α-Fe phase 20c is not produced inside of the Zn—Fe alloy phase 20b (see, FIG. 10) as described above,

Since the coated powder contains the main phase 10 derived from the magnetic powder, the heat treatment is performed at a temperature less than the decomposition temperature of the main phase 10. From this viewpoint, the heat treatment temperature may be 500° C. or less, 490° C. or less, or 480° C. or less. On the other hand, the heat treatment is performed at a temperature equal to or higher than the temperature allowing Zn to diffuse into the oxide phase 10a on the surface of the main phase 10. The diffusion of Zn into the oxide phase 10a on the main phase 10 surface may be either solid phase diffusion or liquid phase diffusion. The liquid phase diffusion means that liquid-phase Zn diffuses into the solid-phase oxide phase 10a. An oxide phase 10a is present at least in a part of the main phase 10 surface, but in a portion where the oxide phase 10a is not present, Zn may diffuse into the main phase 10 surface.

From the viewpoint of allowing solid-phase Zn to undergo solid phase diffusion into the oxide phase 10a on the main phase 10 surface, the heat treatment temperature may be 350° C. or more, 370° C. or more, 390° C. or more, or 410° C. or more. From the viewpoint of allowing liquid-phase Zn to diffuse into the oxide phase 10a on the main phase 10 surface, the heat treatment temperature may be 420° C. or more, 440° C. or more, or 460° C. or more.

The Zn-containing powder mainly contains metallic Zn but may contain a substance other than metallic Zn. The main substance other than metallic Zn is oxygen. When the oxygen content in the Zn-containing powder is 1.0 mass % or less relative to the whole Zn-containing powder, oxygen is easily enriched in the intermediate phase 30 to enhance the coercive force. In view of oxygen enrichment, the oxygen content in the Zn-containing powder is preferably smaller relative to the whole Zn-containing powder. The oxygen content in the Zn-containing powder may be 0.8 mass % or less, 0.6 mass % or less, 0.4 mass % or less, or 0.2 mass'© of less, relative to the whole Zn-containing powder. On the other hand, if the oxygen content in the Zn-containing powder is excessively reduced relative to the whole Zn-containing powder, this leads to an increase in the production cost. For this reason, the oxygen content in the Zn-containing powder may be 0.01 mass % or more, 0.05 mass % or more, or 0.09 mass % or more, relative to the whole Zn-containing powder.

The particle diameter of the Zn-containing powder may be appropriately determined in relation to the particle diameter of the magnetic powder so that an intermediate phase 30 can be formed. The particle diameter of the Zn powder may be, for example, 10 nm or more, 100 nm or more, 1 μm or more, 3 μm or more, or 10 μm or more, and may be 500 μm or less, 300 μm or less, 100 μm or less, 50 μm or less, or 20 μm or less. In the case where the particle diameter of the magnetic powder is from 1 to 10 μm, in order to unfailingly coat the magnetic powder with Zn, the particle diameter of the Zn-containing powder may be 200 μm or less, 100 μm or less, 50 μm or less, or 20 μm or less.

By blending the Zn-containing powder, particles of the coated powder are bound. However, the Zn-containing powder does not contribute to magnetization, and therefore, if an excessive amount of Zn-containing powder is blended, the magnetization decreases. In view of binding of coated powder particles, the Zn-containing powder may be blended such that the Zn component accounts for 1 mass % or more, 3 mass % or more, 6 mass % or more, or 9 mass % or more, relative to the whole mixed powder, From the viewpoint of suppressing the reduction in magnetization, the Zn-containing powder may be blended such that the Zn component accounts for 20 mass % or less, 18 mass % or less, or 16 mass % or less, relative to the whole mixed powder.

The method for mixing the coated powder and the Zn-containing powder is not particularly limited. The “mixing” encompasses an embodiment where the Zn powder is deformed during mixing of both powders to coat the coated powder particle surface with Zn. More specifically, the “mixing” encompasses an embodiment where the coated powder surface is coated with Zn while the Zn-containing powder is mixed with the coated powder. The mixing method includes a method of mixing the powders by using a mortar, a Muller wheel mixer, an agitator mixer, a mechanofusion, a V-type mixer, a ball mill, etc. From the viewpoint of facilitating the coating of the outer periphery of the coated powder particle with Zn, it is preferable to use a mortar and a ball mill. Incidentally, the V-type mixer is an apparatus having a container formed by connecting two cylindrical containers in V shape, in which the container is rotated to cause the powders in the container to repeatedly experience aggregation and separation due to gravity and centrifugal force and thereby be mixed.

In addition, the mixing encompasses deposition mixing of depositing Zn on the coated powder surface. The method for depositing Zn complies with the method of forming a coat on the magnetic powder particle surface, but of course, the deposition thickness of Zn deposited on the coated particle surface is larger than in the case of forming a coat on the magnetic powder particle surface.

In addition, mixing and heat treatment may be performed at the same time by charging the magnetic powder and the Zn-containing powder into a rotary kiln.

The heat treatment time may be appropriately determined according to the amount, etc. of the mixed powder. The heat treatment time excludes the temperature rise time until reaching the heat treatment temperature. The heat treatment time may be, for example, 5 minutes or more, 10 minutes or more, 30 minutes or more, or 50 minutes or more, and may be 600 minutes or less, 240 minutes or less, or 120 minutes or less.

After the elapse of the heat treatment time, the heat treatment is terminated by rapidly cooling the heat-treatment object. Oxidation, etc. of the rare earth magnet 100 of the present disclosure can be prevented by rapid cooling. The rapid cooling rate may be, for example, from 2 to 200° C./sec.

The heat treatment is preferably performed in an inert gas atmosphere or in vacuum so as to prevent oxidation of the mixed powder. The inert gas atmosphere includes a nitrogen gas atmosphere.

Besides the hereinbefore-described coated powder preparation step and heat treatment step, the following steps may be added.

### <Compression Molding Step>

The mixed powder may be, before heat treatment, compression-molded to obtain a green compact, and the green compact may be heat-treated. When the mixed powder is compression-molded, individual particles of the mixed powder are closer together, so that a good intermediate phase 30 can be formed and the coercive force can be enhanced. The compression molding method may be a conventional method such as pressing using a mold. The pressing pressure may be, for example, 50 MPa or more, 100 MPa or more, or 150 MPa or more, and may be 1,500 MPa or less, 1,000 MPa or less, or 500 MPa or less.

The compression molding of the mixed powder may be performed in a magnetic field. By this molding, orientation can be imparted to the green compact, and the magnetization can he enhanced. The method for compression molding in a magnetic field may be a method generally performed at the time of production of a magnet. The magnetic field applied may be, for example, 0.3 T or more, 0.5 T or more, or 1.0 T or more, and may be 5.0 T or less, 4.0 T or less, or 3.0 T or less.

### <Sintering>

One embodiment of heat treatment includes performing the heat treatment while applying pressure, for example, sintering. In the production method of the present disclosure, the mixed powder or green compact may be heat-treated while pressure is applied, i.e., may be sintered. In the sintering, pressure is applied to the mixed powder or green compact, and therefore the effect due to heat treatment is unfailingly obtained in a short time. The sintering encompasses liquid-phase sintering in which a part of the sintering object becomes a liquid phase.

Sintering conditions are described below. The sintering temperature may be determined with reference to the above-described heat treatment temperature. The sintering pressure may be, typically, 50 MPa or more, 100 MPa or more, 200 MPa or more, or 400 MPa or more, and may be 2 GPa or less, 1.5 GPa or less, 1.0 GPa or less, or 700 MPa or less. In the sintering, pressure is applied to the mixed powder or green compact, and therefore the sintering time may be short compared with the above-described heat treatment time. The sintering time may be, typically, 1 minute or more, 3 minutes or more, or 5 minutes or more, and may be 120 minutes or less, 60 minutes or less, or 40 minutes or less. In the sintering, it may also be possible to apply no pressure until reaching the desired temperature and start applying pressure after reaching the desired temperature. In this case, the sintering time is preferably the time from the start of applying pressure.

After the elapse of the sintering time, the sintering is terminated by taking out the sintering object from the mold. The sintering is preferably performed in an inert gas atmosphere or in vacuum so as to prevent oxidation of the coated powder and the Zn-containing powder. The inert gas atmosphere includes a nitrogen gas atmosphere.

The sintering method may be a conventional method and includes, for example, Spark Plasma Sintering (SPS) and hot press. In the case of intending to apply pressure after the sintering object has reached the desired temperature, hot press is preferred.

At the time of sintering, typically, a mold made of cemented carbide or iron and steel material is used, but the present disclosure is not limited thereto. Here, the cemented carbide is an alloy obtained by sintering tungsten carbide and cobalt as a binder. The iron and steel material used for the mold includes, for example, carbon steel, alloy steel, tool steel and high-speed steel. The carbon steel includes, for example, SS540, S45C, and S15CK of the Japanese Industrial Standards. The alloy steel includes, for example, SCr445, SCM445, and SNCM447 of the Japanese Industrial Standards. The tool steel includes, for example, SKD5, SKD61, and SKT4 of the Japanese Industrial Standards. The high-speed steel includes, for example, SKH40, SKH55, and SKH59 of the Japanese Industrial Standards.

### EXAMPLES

The rare earth magnet of the present disclosure and the production method thereof are described more specifically below by referring to Examples and Comparative Examples. Incidentally, the rare earth magnet of the present disclosure and the production method thereof are not limited to the conditions employed in the following Examples.

### <<Preparation of Sample>>

Samples of the rare earth magnet were prepared in the following manner.

### Examples 1 to 3

A magnetic powder mainly containing Sm₂Fe₁₇N₃ was prepared. The oxygen content in the magnetic powder was 1.05 mass %. A 2 nm-thick coat containing Si and P was formed on the magnetic powder particle surface by a method of mixing alkoxysilicon and phosphoric acid to obtain a coated powder. Incidentally, the thickness of the coat was confirmed by XPS. In addition, a Zn powder produced by a hydrogen plasma-metal reaction method (HPMR method) was prepared. The Zn powder had a particle diameter of 0.6 μm and an oxygen content of 0.05 mass %. Then, the coated powder and the Zn powder were mixed using a mechanofusion to obtain a mixed powder.

The mixed powder was compression-molded in a magnetic field to obtain a green compact. The pressure of the compression molding was 400 MPa. The magnetic field applied was 2 T. Subsequently, the green compact was charged into a cemented carbide-made mold and sintered in an argon gas atmosphere to obtain a sintered body. This sintered body was used as samples of Examples 1 to 3. As for the sintering conditions, the green compact in the mold was heated to a predetermined temperature, held at the predetermined temperature for 5 minutes, and held for 5 minutes while the predetermined temperature was kept and a pressure of 300 MPa was applied to the green compact. The predetermined temperature above is defined as the sintering temperature.

### Comparative Examples 1 to 3

Samples of Comparative Examples 1 to 3 were produced in the same manner as in Examples 1 to 3 except that a coat was not formed on the magnetic powder particle surface.

### <<Evaluation>>

Each sample was evaluated for the magnetization curve and coercive force Hc by using a pulse excited magnetometer (TPM) and the residual magnetic flux Br by using a vibrating sample magnetometer (VSM). The measurements were performed at room temperature. In addition, with respect to the Zn—Fe alloy phase 20b, each sample was subjected to formation phase identification by using STEM-EDX, electron beam diffraction and XRD. Incidentally, the formation phase identification was performed by STEM-EDX, electron beam diffraction and XRD, and it was confirmed that there is no difference in the results among respective measurements. Then, each sample was measured for the average Fe content in the sub-phase 20 by using SEM-EDX and STEM-EDX. Here, the average Fe content in the sub-phase 20 was measured by SEM-EDX and STEM-EDX, and it was confirmed that there is no difference in the results between respective measurements.

The evaluation results are shown in Table 2. In Table 2, the properties of the coated powder and the sintering temperature are shown together. Incidentally, “Si Content” in Table 2 is the measurement result of Si content relative to the coated powder measured using an induction coupled plasma (ICP) emission spectrophotometer.

TABLE 2

| | Coated Powder | | | | Magnetic Properties | | | | Sub-Phase | |
|---|---|---|---|---|---|---|---|---|---|---|
| | | Thickness | Si | Sintering | | | | Percentage | | Average Fe |
| | | of Coat | Content | Temperature | Hc | Hc | Br | of Knick | Formation | content |
| | Type of Coat | (nm) | (mass %) | (° C.) | (kOe) | (kA/m) | (kG) | (%) | Phase | (at %) |
| Example 1 | containing Si, P | 2 | 0.045 | 425 | 9.3 | 740 | 8.5 | 0 | Γ phase | 7.0 |
| Example 2 | containing Si, P | 2 | 0.045 | 450 | 11.9 | 950 | 8.4 | 0 | Γ phase | 12.6 |
| Example 3 | containing Si, P | 2 | 0.045 | 475 | 12.3 | 980 | 8.3 | 0 | Γ phase | 30.6 |
| Comparative | none | — | 0.026 | 425 | 18.5 | 1470 | 8.0 | 6.0 | α phase + | 41.0 |
| Example 1 | | | | | | | | | Γ phase | |
| Comparative | none | — | 0.026 | 450 | 20.1 | 1600 | 7.9 | 8.6 | α phase + | 45.6 |
| Example 2 | | | | | | | | | Γ phase | |
| Comparative | none | — | 0.026 | 475 | 29.7 | 2360 | 7.1 | 17.0 | α phase + | 54.5 |
| Example 3 | | | | | | | | | Γ phase | |

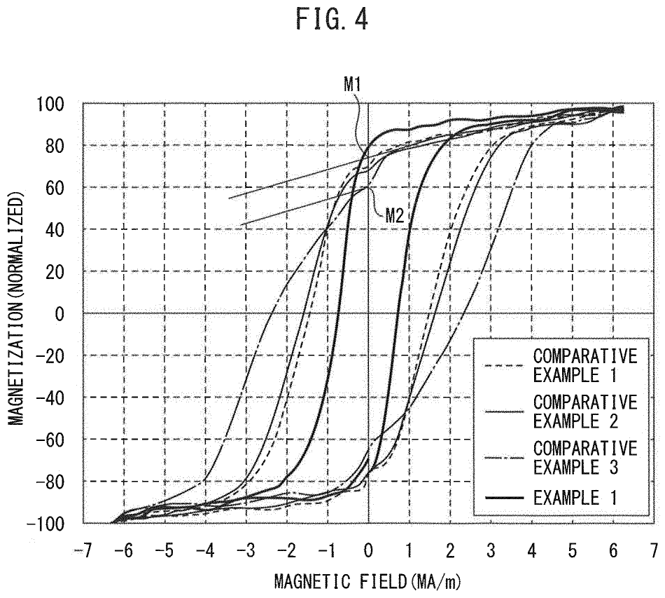

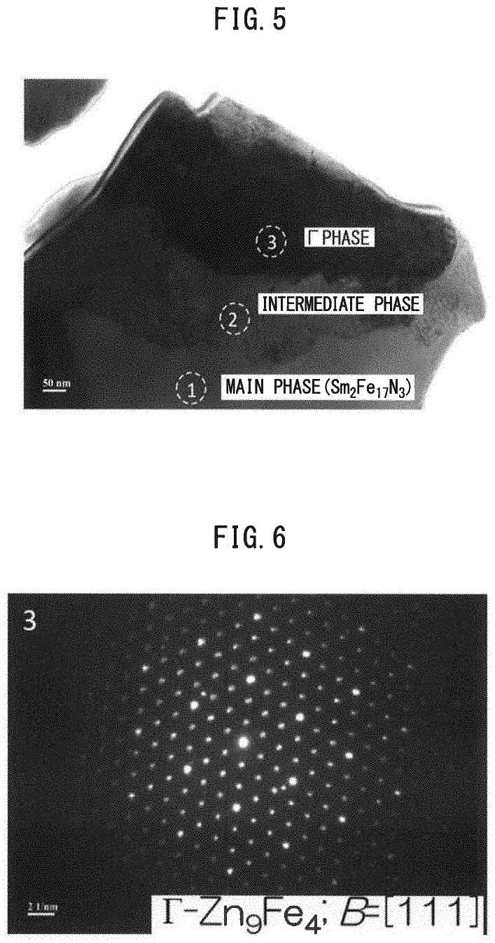

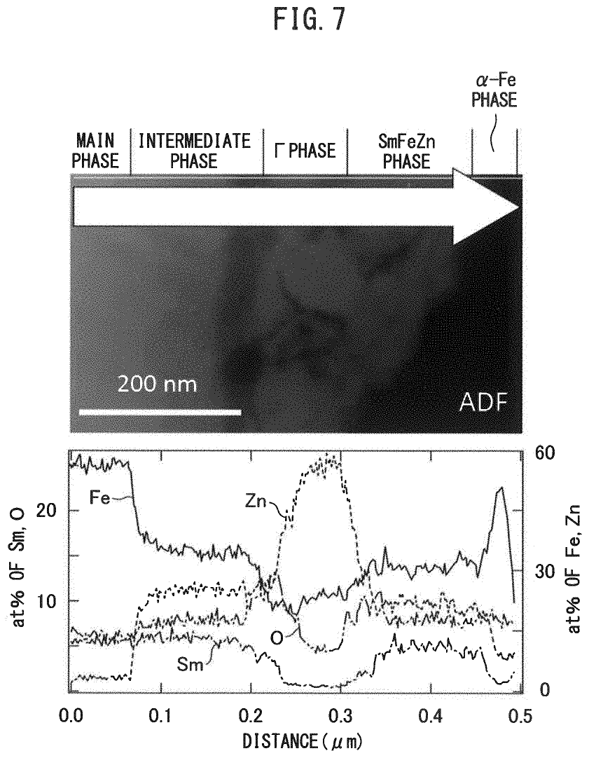

FIG. 4 is an M-H curve with respect to Example 1 and Comparative Examples 1 to 3. In FIG. 4, with respect to Comparative Example 3, the method for calculating the “percentage of knick” shown in Table 2 is illustrated together. FIG. 5 is a diagram illustrating TEM observation results with respect to the sample of Example 3. FIG. 6 is a diagram illustrating an electron beam diffraction pattern of the region denoted by “3” in FIG. 5. FIG. 7 is a diagram illustrating TEM observation results and TEM-EDX line analysis results with respect to the sample of Comparative Example 3.

From Table 2, it could be confirmed that in the samples of Examples 1 to 3 where a coat containing Si and P is applied to the magnetic powder particle surface, a knick is not generated. In addition, it could be confirmed that in the sub-phases of the samples of Examples 1 to 3, an α-Fe phase is not produced. Furthermore, it could be confirmed that with respect to the samples of Examples 1 to 3, the Fe content in the sub-phase is 33 mass % or less. Incidentally, the Si content in the samples of Comparative Examples 1 to 3 is considered to be the content of an unavoidable impurity contained in the magnetic powder.

It could also be confirmed from FIGS. 5 and 6 that in the sample of Example 3, the intermediate phase is adjacent to the main phase (Sm₂Fe₁₇N₃) and a Γ phase is adjacent to the intermediate phase. Moreover, it could be confirmed from FIG. 7 that an α-Fe phase is produced in the sample of Comparative Example 3, and generation of a knick could thereby be understand.

These results could verify the effects of the rare earth magnet of the present disclosure and the production method thereof.

### DESCRIPTION OF NUMERICAL REFERENCES

10 Main phase
10a Oxide phase
20a Zn phase
20b Zn—Fe alloy phase
20c α-Fe phase
20 Sub-phase
30 Intermediate phase
50 Interface
60 Coat
100 Rare earth magnet of the present disclosure
900 Conventional rare earth magnet

1. A rare earth magnet comprising:
a main phase containing Sm, Fe, and N, at least a part of the main phase having a Th₂Zn₁₇-type or Th₂Ni₁₇-type crystal structure,
a sub-phase containing Zn and Fe and being present around the main phase, and
an intermediate phase containing Sm, Fe and N as well as Zn and being present between the main phase and the sub-phase,
wherein the average Fe content in the sub-phase is 33 at % or less relative to the whole sub-phase.

2. The rare earth magnet according to claim 1, wherein the average Fe content in the sub-phase is from 1 to 33 at % relative to the whole sub-phase.

3. The rare earth magnet according to claim 1, wherein the sub-phase contains one or more Zn—Fe alloy phases selected from the group consisting of a Γ phase, a Γ₁ phase, a δ₁ₖ phase, a δ₁ₚ phase, and ζ phase.

4. The rare earth magnet according to claim 1, wherein the main phase contains a phase represented by (Sm₍₁₋ᵢ₎R¹ᵢ)₂(Fe₍₁₋ⱼ₎Coⱼ)₁₇Nₕ (wherein R¹ is one or more elements selected from the group consisting of Y, Zr, and rare earth elements other than Sm, i is from 0 to 0.50, j is from 0 to 0.52, and h is from 1.5 to 4.5).

5. The rare earth magnet according to claim 1, wherein the main phase contains a phase represented by Sm₂Fe₁₇Nₕ (wherein h is from 1.5 to 4.5).

6. The rare earth magnet according to claim 1, wherein the main phase contains a phase represented by Sm₂Fe₁₇N₃.

7. A method for producing a rare earth magnet, comprising:
forming a coat containing one or more elements selected from the group consisting of Si, P, Al, S, Ti, V, Ge, Y, La, Ce, Zr, Nb, Mo, Sn, Ta, Sm, and W on a particle surface of a magnetic powder comprising a main phase containing Sm, Fe and N, at least a part of the main phase having a Th₂Zn₁₇-type or Th₂Ni₁₇-type crystal structure to obtain a coated powder, and
heat-treating a mixed powder of a Zn-containing powder and the coated powder in an inert gas atmosphere or in vacuum at a temperature equal to or higher than the temperature allowing Zn to diffuse into the oxide phase on the surface of the main phase and less than the decomposition temperature of the main phase.

8. The method according to claim 7, wherein the coat has a thickness of 1 to 10 nm.

9. The method according to claim 7, wherein the coat contains one or more coats selected from the group consisting of a phosphoric acid-based coat, a zinc phosphate-based coat, a silica-based coat, and an alkoxysilicon-based coat.

10. The method according to claim 7, wherein the coat contains Si and P.

11. The method according to claim 10, wherein in the coat, Si is contained in an amount of 0.040 to 0.100 mass % relative to the coated powder.

12. The method according to claim 7, wherein the mixed powder is compression-molded to obtain a green compact and the green compact is heat-treated.

13. The method according to claim 12, wherein the compression molding is performed in a magnetic field.

14. The method according to claim 7, wherein the mixed powder or green compact is heat-treated while pressure is applied.

15. The method according to claim 7, wherein the main phase contains a phase represented by (Sm₍₁₋ᵢ₎R¹ᵢ)₂(Fe₍₁₋ⱼ₎Coⱼ)₁₇Nₕ (wherein R¹ is one or more elements selected from the group consisting of Y, Zr, and rare earth elements other than Sm, i is from 0 to 0.50, j is from 0 to 0.52, and h is from 1.5 to 4.5).

16. The method according to claim 7, wherein the main phase contains a phase represented by Sm₂Fe₁₇Nₕ (wherein h is from 1.5 to 4.5).

17. The method according to claim 7, wherein the main phase contains a phase represented by Sm₂Fe₁₇N₃.

18. The method according to claim 7, wherein the heat treatment is performed at 350 to 500° C.

19. The method according to claim 7, wherein the heat treatment is performed at 420 to 500° C.
